(19) United States
(12) Patent Application Publication
(10) Pub. No.: US 2025/0340101 A1
(43) Pub. Date: Nov. 6, 2025

(54) WINDOW GLASS FOR VEHICLE

(71) Applicant: AGC Inc., Tokyo (JP)

(72) Inventors: Toshiki SAYAMA, Tokyo (JP); Shoichi TAKEUCHI, Tokyo (JP); Hideaki SHOJI, Tokyo (JP); Kazuya MATSUMOTO, Tokyo (JP); Yusuke KATO, Tokyo (JP)

(73) Assignee: AGC Inc., Tokyo (JP)

(21) Appl. No.: 19/269,959

(22) Filed: Jul. 15, 2025

Related U.S. Application Data
(63) Continuation of application No. PCT/JP2024/001235, filed on Jan. 18, 2024.

(30) Foreign Application Priority Data
Jan. 23, 2023 (JP) 2023-008284

(51) Int. Cl. B60J 1/00; B60J 1/02; B60J 1/18; H05B 3/86

(52) U.S. Cl. CPC B60J 1/002; B60J 1/02; B60J 1/18; H05B 3/86

(57) ABSTRACT

A window glass for a vehicle includes: a glass plate having a main surface; and a plurality of linear conductors provided on the glass plate, extending in a first direction along the main surface, and arranged at intervals in a second direction perpendicular to the first direction, wherein −2≤εₑ≤4 when −45°≤α≤+45°. A direction perpendicular to the first and second directions is a third direction. A plane including the second and third directions is a first plane. A direction in which a radio wave whose electric field oscillates perpendicular to the first plane travels along the first plane is a first traveling direction. An angle between the first traveling direction and the third direction is α. An effective relative permittivity at a frequency of the radio wave in a region where the plurality of linear conductors are provided is εₑ.

### INCORPORATION BY REFERENCE

This application is based upon and claims the benefit of priority from Japanese Patent Application No. 2023-008284 filed on Jan. 23, 2023, and PCT application No. PCT/JP2024/001235 filed on Jan. 18, 2024, the disclosure of which is incorporated herein in its entirety by reference.

### BACKGROUND

Hitherto, a window glass for a vehicle including a plurality of wires arranged on a glass plate is known (see, for example, Patent Literature 1).
Patent Literature 1: Japanese Unexamined Patent Application Publication No. H9-207718
Non Patent Literature 1: X. Chen, T. Grzegorczyk, B. Wu, J. Pacheco Jr, and J. Kong, “Robust method to retrieve the constitutive effective parameters of metamaterials,” Physical Review E 70, 016608 (2004).

### SUMMARY

However, a plurality of linear conductors such as the above-described wires may interfere with transmission of a radio wave arriving from the outside of the vehicle or a radio wave radiated from an antenna disposed in the vehicle through the glass plate. In this case, a transmittance of the radio wave through the glass plate is reduced, and thus, transmission and reception of the radio wave through the glass plate may be hindered.

The present disclosure provides a window glass for a vehicle that includes a glass plate on which a plurality of linear conductors are provided and is capable of securing a transmittance of a radio wave through the glass plate.

A window glass for a vehicle according to one embodiment of the present disclosure includes:
a glass plate having a main surface; and
a plurality of linear conductors provided on the glass plate, extending in a first direction along the main surface, and arranged at intervals in a second direction which is at a right angle to the first direction,
wherein εₑ is −2 or more and 4 or less when α is in a range from −45° to +45°, in which a direction which is at a right angle to the first direction and the second direction is a third direction, a plane including the second direction and the third direction is a first plane, a direction in which a radio wave having a component whose electric field oscillates in a direction perpendicular to the first plane travels along the first plane is a first traveling direction, an angle formed by the first traveling direction and the third direction is α, and an effective relative permittivity at a frequency of the radio wave in a region where the plurality of linear conductors are provided on the glass plate is εₑ.

With the window glass for a vehicle of one embodiment of the present disclosure, it is possible to secure a transmittance of a radio wave through a glass plate on which a plurality of linear conductors are provided.

The above and other objects, features and advantages of the present disclosure will become more fully understood from the detailed description given hereinbelow and the accompanying drawings.

### BRIEF DESCRIPTION OF DRAWINGS

FIG. 1 is a perspective view illustrating a situation in which a radio wave (linearly polarized wave) having a component whose electric field oscillates in a direction parallel to a plurality of linear conductors provided on a glass plate is transmitted through the glass plate;

FIG. 2 is a perspective view illustrating a situation in which a radio wave (linearly polarized wave) having a component whose electric field oscillates in a direction in which the plurality of linear conductors provided on the glass plate are arranged is transmitted through the glass plate;

FIG. 3 is a perspective view illustrating a situation in which a radio wave (circularly polarized wave) having a component whose electric field oscillates in the direction parallel to the plurality of linear conductors provided on the glass plate is transmitted through the glass plate;

FIG. 4 is a schematic perspective view of a window glass for a vehicle on which a radio wave is incident at an incident angle α in an XY plane;

FIG. 5 is a schematic perspective view of the window glass for a vehicle on which a radio wave is incident at an incident angle β in a YZ plane;

FIG. 6 is a plan view illustrating a specific example of the window glass for a vehicle;

FIG. 7 is a cross-sectional view illustrating an upper portion of the specific example of the window glass for a vehicle;

FIG. 8 is a view illustrating the plurality of linear conductors provided on the glass plate;

FIG. 9 is a diagram illustrating an example of a relationship among a pitch between adjacent linear conductors, the incident angle α of the radio wave on the glass plate, a frequency of the radio wave, and a transmittance of the radio wave through the glass plate;

FIG. 10 is a diagram illustrating an example of a relationship among the pitch between adjacent linear conductors, the incident angle α of the radio wave on the glass plate, the frequency of the radio wave, and an effective relative permittivity; and

FIG. 11 is a diagram illustrating an example of a result of actually measuring an average antenna gain using an actual vehicle.

### DESCRIPTION OF EMBODIMENTS

Hereinafter, embodiments will be described with reference to the drawings. For easy understanding, the scale of each part in the drawings may be different from the actual scale. In directions such as parallel, right angle, orthogonal, horizontal, vertical, up and down, and left and right, and terms such as the same and equal, deviations are allowed to an extent that do not impair functions and effects of the embodiments. The shape of a corner portion is not limited to a right angle, and may be rounded in an arch shape. The term “facing” is not limited to a form in which all of them face each other, and may include a form in which some of them face each other. The term “overlapping” is not limited to a form in which all of them overlap each other, and may include a form in which some of them overlap each other.

An X-axis direction, a Y-axis direction, and a Z-axis direction represent a direction parallel to an X axis, a direction parallel to a Y axis, and a direction parallel to a Z axis, respectively. The X-axis direction, the Y-axis direction, and the Z-axis direction are orthogonal to each other. An XY plane, a YZ plane, and a ZX plane represent a virtual plane parallel to the X-axis direction and the Y-axis direction, a virtual plane parallel to the Y-axis direction and the Z-axis direction, and a virtual plane parallel to the Z-axis direction and the X-axis direction, respectively.

As an example of a window glass for a vehicle in the present embodiment, a windshield attached to a front portion of a vehicle is preferable. However, the window glass for a vehicle is not limited to the windshield, and may be, for example, a rear glass attached to a rear portion of the vehicle, a side glass attached to a side portion of the vehicle, or a roof glass attached to a ceiling portion of the vehicle. The window glass for a vehicle may be a window glass in which the roof glass is integrated with one or both of the windshield and the rear glass.

First, a situation in which a radio wave passes through a glass plate on which a plurality of linear conductors are provided will be described with reference to FIGS. 1, 2, and 3.

FIGS. 1, 2, and 3 are views illustrating a situation in which a radio wave passes through a glass plate 1 on which a plurality of linear conductors 27 are provided. The glass plate 1 illustrated in FIGS. 1, 2, and 3 has a main surface 20. The glass plate 1 is disposed such that the main surface 20 is parallel to the ZX plane. The plurality of linear conductors 27 extend in the Z-axis direction along the main surface 20 and are arranged at intervals in the X-axis direction which is at a right angle to the Z-axis direction.

FIG. 1 is a perspective view illustrating a situation in which a radio wave VP whose electric field oscillates in the Z-axis direction perpendicular to the XY plane is transmitted through the glass plate 1. In a case where the XY plane is parallel to a horizontal plane, the radio wave VP is also referred to as a “vertically polarized radio wave” or simply a “vertically polarized wave”. Since the radio wave VP has a component whose electric field oscillates in the Z-axis direction perpendicular to the XY plane (the Z-axis direction in which the plurality of linear conductors 27 extend), the degree of exciting the plurality of linear conductors 27 increases. For this reason, depending on a frequency of the radio wave VP, the radio wave VP is significantly attenuated in the glass plate 1 and is transmitted through the glass plate 1, as a result of which a transmittance of the radio wave VP passing through the glass plate 1 may be significantly reduced.

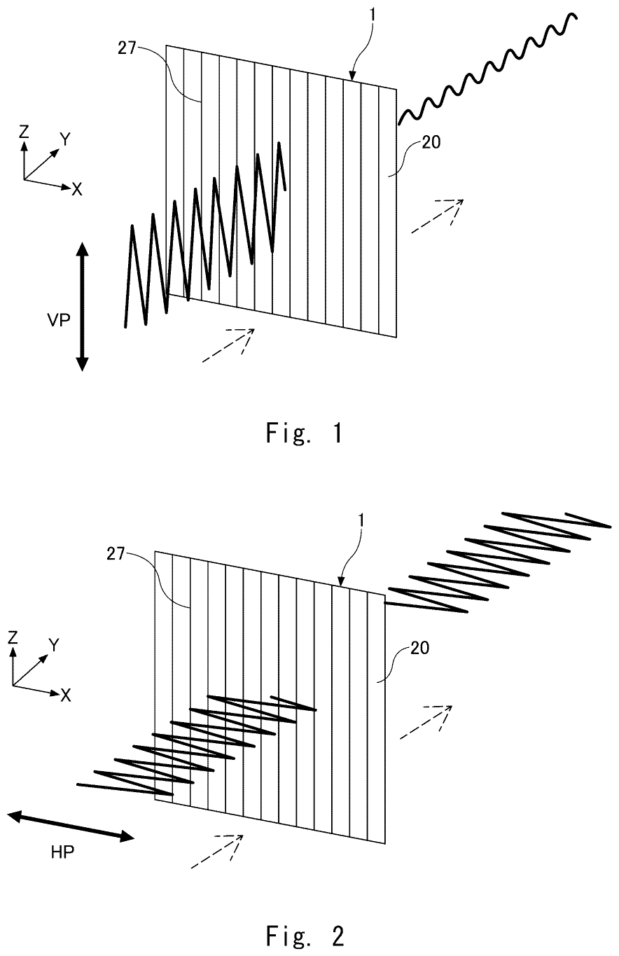

FIG. 2 is a perspective view illustrating a situation in which a radio wave HP whose electric field oscillates in the X-axis direction parallel to the XY plane is transmitted through the glass plate 1. In a case where the XY plane is parallel to the horizontal plane, the radio wave HP is also referred to as a “horizontally polarized radio wave” or simply a “horizontally polarized wave”. Since the radio wave HP has a component whose electric field oscillates in the X-axis direction in which the plurality of linear conductors 27 are arranged at intervals, the degree of exciting the plurality of linear conductors 27 is lower than that in the case of FIG. 1. Therefore, the radio wave HP passes through the glass plate 1 with little attenuation in the glass plate 1.

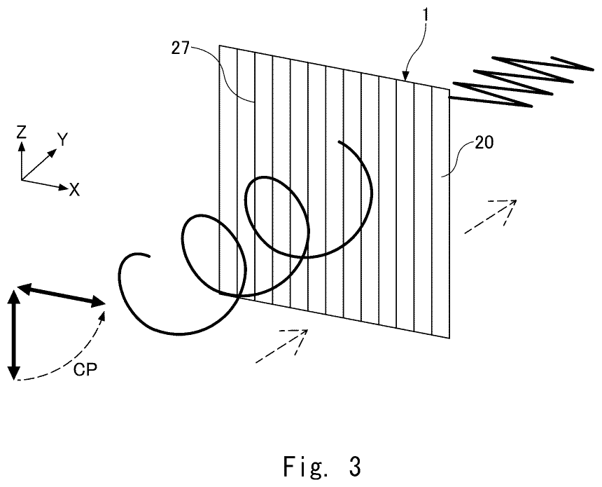

FIG. 3 is a perspective view illustrating a situation in which a radio wave CP in which an oscillation direction of an electric field rotates on the ZX plane is transmitted through the glass plate 1. The radio wave CP is also referred to as a “circularly polarized radio wave” or simply a “circularly polarized wave”. Since the radio wave CP has a component whose electric field oscillates in the Z-axis direction (the Z-axis direction in which the plurality of linear conductors 27 extend) perpendicular to the XY plane, the degree of exciting the plurality of linear conductors 27 is lower than that in the case of FIG. 1, but is higher than that in the case of FIG. 2. Therefore, depending on a frequency of the radio wave CP, the radio wave CP is attenuated in the glass plate 1 and passes through the glass plate 1, as a result of which a transmittance of the radio wave VP passing through the glass plate 1 may be reduced.

As described above, for a radio wave having a component whose electric field oscillates in the Z-axis direction (the Z-axis direction in which the plurality of linear conductors 27 extend) perpendicular to the XY plane, the plurality of linear conductors 27 may reduce a transmittance of the radio wave when transmitted through the glass plate 1. Next, the window glass for a vehicle capable of securing a transmittance of a radio wave when transmitted through the glass plate 1 will be described.

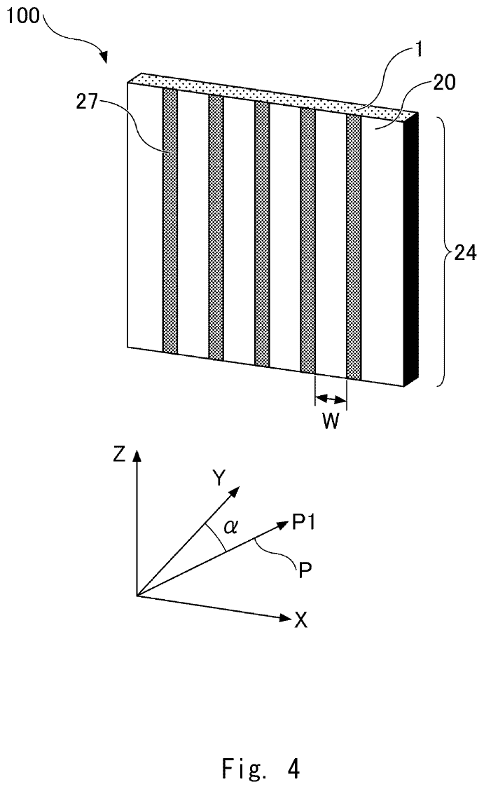

FIG. 4 is a schematic perspective view of a window glass 100 for a vehicle in the present embodiment. The window glass 100 includes the glass plate 1 for a vehicle and the plurality of linear conductors 27. FIG. 4 illustrates a part of a region 24 in which the plurality of linear conductors 27 are provided on the glass plate 1.

The glass plate 1 has the main surface 20. The glass plate 1 is disposed such that the main surface 20 is parallel to the ZX plane. The main surface 20 may be a vehicle-exterior-side surface of the glass plate 1 or a vehicle-interior-side surface of the glass plate 1.

The plurality of linear conductors 27 are provided on the glass plate 1. The plurality of linear conductors 27 may be provided on the main surface 20 of the glass plate 1 or may be provided on an inner layer of the glass plate 1. The plurality of linear conductors 27 extend in the Z-axis direction along the main surface 20 and are arranged at intervals in the X-axis direction which is at a right angle to the Z-axis direction. The Z-axis direction is an example of a first direction. The X-axis direction is an example of a second direction that is at a right angle to the first direction.

A radio wave P has a component whose electric field oscillates in the Z-axis direction perpendicular to the XY plane. The radio wave P propagates in a first traveling direction P1 along the XY plane. The radio wave P may be the radio wave VP or the radio wave CP. The radio wave P is incident on the main surface 20 at an incident angle α which is an angle formed by the first traveling direction P1 and the Y-axis direction. The incident angle α is an angle in the XY plane. The incident angle α is an acute angle of −80° or more and +80° or less, and when the first traveling direction P1 is aligned with the Y-axis direction, the incident angle α is 0°. The Y-axis direction is an example of a third direction which is at a right angle to the first direction and the second direction. The XY plane is an example of a first plane including the second direction and the third direction.

The window glass 100 of the present embodiment satisfies a requirement (hereinafter, also referred to as a requirement R) that a relative permittivity εₑ is −2 or more and 4 or less when α is in a range from −45° to +45°, where εₑ represents an effective relative permittivity at a frequency of the radio wave P in the region 24. If the effective relative permittivity εₑ is 1, it can be considered that an object that blocks the radio wave P does not exist in a space through which the radio wave P is transmitted. As the effective relative permittivity εₑ is closer to 1, a transmittance of the radio wave through the region 24 is improved. Therefore, if the requirement R is satisfied, a transmittance of the radio wave P incident on the glass plate 1 at the incident angle α from −45° to +45° is secured.

If the window glass 100 satisfies the requirement R, a transmittance of the radio wave P incident on the glass plate 1 at the incident angle α from +45° to +80° or from −80° to −45° is also secured as shown in Example 1 described below. That is, the transmittance of the radio wave P incident on the glass plate 1 at the incident angle α from −80° to +80° is secured. As a result, a range (an angular range centered on an antenna) in which the antenna disposed on a vehicle interior side with respect to the window glass 100 can transmit and receive the radio wave P with a high antenna gain through the window glass 100 is expanded, so that a wide range of directivity can be secured.

The effective relative permittivity εₑ may be a value calculated by a function of a known electromagnetic field simulator. For example, the effective relative permittivity εₑ is calculated from S parameters (S11 and S21) based on a calculation method disclosed in Non Patent Literature 1.

When a length (pitch W) of an interval between adjacent linear conductors 27 in the X-axis direction is 2 mm or more and 4 mm or less, a transmittance of the radio wave P in a 5.8 GHz band or a 5.9 GHz band is secured while securing original performance of the linear conductors 27. The original performance of the linear conductor 27 corresponds to, for example, performance of heating the glass plate 1 in a case where the linear conductor 27 is a heating wire, and corresponds to, for example, performance of adjusting the directivity of the radio wave in a case where the linear conductor 27 is a non-powered conductive wire. When the pitch W is 2 mm or less, visibility of a field of view through the glass plate 1 decreases.

The pitch W is preferably 2.5 mm or more and 3.8 mm or less, and more preferably 3.0 mm or more and 3.6 mm or less from the viewpoint of securing the transmittance of the radio wave P in the 5.8 GHz band or the 5.9 GHz band while securing the original performance of the linear conductors 27.

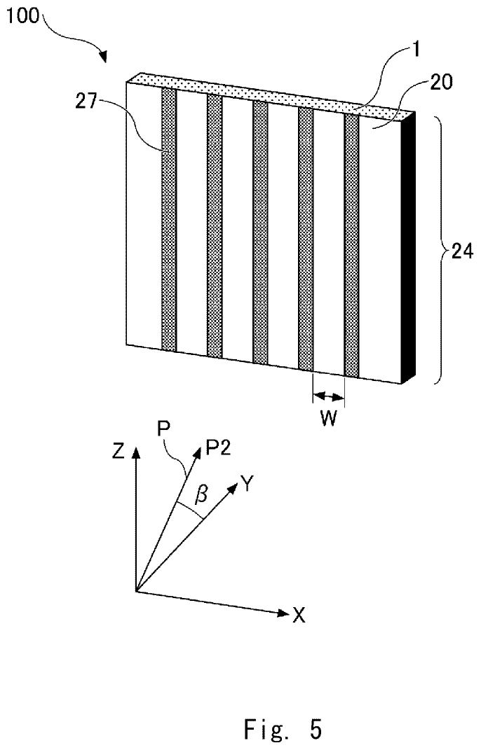

FIG. 5 is a schematic perspective view of the window glass 100 for a vehicle according to the present embodiment. FIG. 5 illustrates a case where the radio wave P is incident on the main surface 20 at an incident angle β. The radio wave P has a component whose electric field oscillates in the Z-axis direction perpendicular to the XY plane. The radio wave P propagates in a second traveling direction P2 along the YZ plane. The radio wave P may be the radio wave VP or the radio wave CP. The radio wave P is incident on the main surface 20 at the incident angle β which is an angle formed by the second traveling direction P2 and the Y-axis direction. The incident angle β is an angle in the YZ plane. The incident angle β is an acute angle of −80° or more and +80° or less, and when the second traveling direction P2 is aligned with the Y-axis direction, the incident angle β is 0°.

When the pitch W changes, the effective relative permittivity εₑ also changes. Therefore, by adjusting the pitch W to an appropriate value, an effect of improving the transmittance of the radio wave P having a desired frequency and incident on the glass plate 1 (in other words, an effect of bringing the effective relative permittivity εₑ close to 1) can be obtained. However, even when the pitch W changes, an effect of improving the transmittance of the radio wave P incident on the glass plate 1 at the incident angle β is less than an effect of improving the transmittance of the radio wave P incident on the glass plate 1 at the incident angle α. This is because the Z-axis direction in which the plurality of linear conductors 27 extend is parallel to the YZ plane in which the incident angle β changes.

Next, a specific example of the window glass for a vehicle will be described.

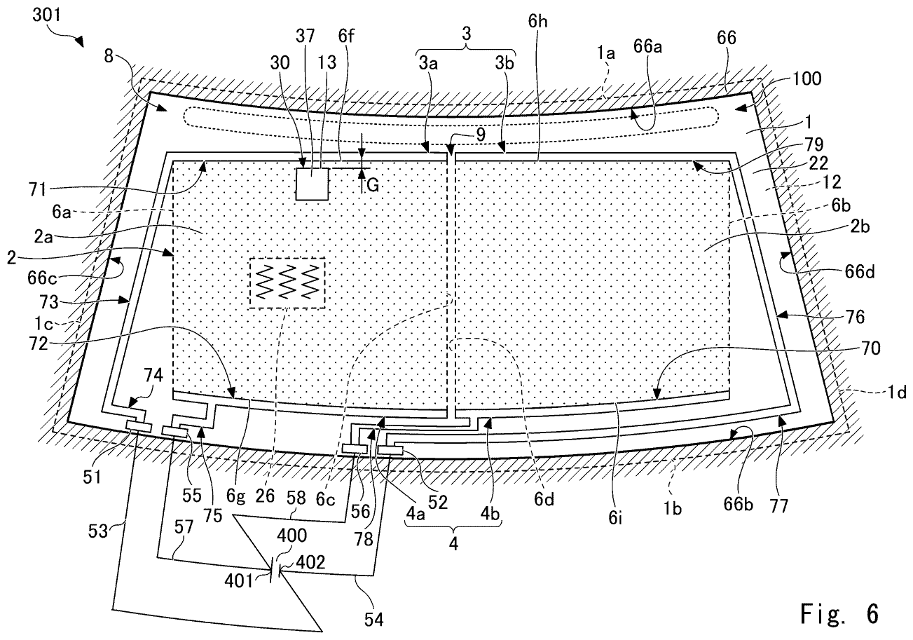

FIG. 6 is a view illustrating a specific example of the window glass for a vehicle from the viewpoint of the vehicle interior side. A window glass device 301 for a vehicle illustrated in FIG. 6 includes the window glass 100 attached to a window frame 66 formed in a vehicle body. The window glass 100 illustrated in FIG. 1 is a windshield attached to the window frame 66 formed at the front portion of the vehicle body.

The window frame 66 has an upper frame 66a, a lower frame 66b, a left frame 66c, and a right frame 66d to form an opening covered by the window glass 100. The upper frame 66a is a window frame portion extending in a lateral direction on an upper side of the vehicle body, and is, for example, a flange on a ceiling side of the vehicle body. The lower frame 66b is a window frame portion extending in the lateral direction on a lower side of the vehicle body, and is, for example, a flange on a dash panel side of the vehicle body. The left frame 66c is a window frame portion connecting the upper frame 66a and the lower frame 66b on a left side of the vehicle body, and is, for example, an A-pillar flange on a front-left side of the vehicle body. The right frame 66d is a window frame portion connecting the upper frame 66a and the lower frame 66b on a right side of the vehicle body, and is, for example, an A-pillar flange on a front-right side of the vehicle body.

The window glass device 301 for a vehicle includes the window glass 100 attached to the window frame 66 and an antenna 30 disposed in a space on the vehicle interior side of the glass plate 1 of the window glass 100. The window glass 100 includes the glass plate 1, a first bus bar 3, and a second bus bar 4.

The glass plate 1 is an example of a glass plate for a vehicle. The glass plate 1 is a transparent or translucent dielectric plate attached to the window frame 66. The glass plate 1 has an outer peripheral edge including an upper edge 1a, a lower edge 1b, a left edge 1c, and a right edge 1d. The upper edge 1a is a glass edge extending in the lateral direction on the upper side of the vehicle body, and is attached to the upper frame 66a. The lower edge 1b is a glass edge extending in the lateral direction on the lower side of the vehicle body, and is attached to the lower frame 66b. The left edge 1c is a glass edge connecting the upper edge 1a and the lower edge 1b on the left side of the vehicle body, and is attached to the left frame 66c. The right edge 1d is a glass edge connecting the upper edge 1a and the lower edge 1b on the right side of the vehicle body, and is attached to the right frame 66d.

The glass plate 1 has a main surface 22 and a main surface 12 opposite to the main surface 22. In this example, the main surface 22 is a surface on the vehicle interior side, and the main surface 12 is a surface on a vehicle exterior side. The main surface 22 or the main surface 12 is an example of the main surface 20 described above.

The first bus bar 3 is a strip-shaped electrode provided on the glass plate 1. The first bus bar 3 includes upper portions 71 and 79 extending in a direction (for example, in a substantially horizontal direction) along the upper edge 1a of the glass plate 1. The first bus bar 3 is conductively connected to one electrode terminal (for example, a negative electrode terminal 402) of a power supply 400 mounted on the vehicle.

The second bus bar 4 is a strip-shaped electrode provided on the glass plate 1. The second bus bar 4 includes lower portions 72 and 70 extending in a direction (for example, in a substantially horizontal direction) along the lower edge 1b of the glass plate 1. The second bus bar 4 is conductively connected to the other electrode terminal (for example, a positive electrode terminal 401) of the power supply 400 mounted on the vehicle.

The first bus bar 3 may be conductively connected to the positive electrode terminal 401 of the power supply 400, and the second bus bar 4 may be conductively connected to the negative electrode terminal 402 of the power supply 400.

The glass plate 1 has a heated region 2 extending between the upper portions 71 and 79 and the lower portions 72 and 70. The heated region 2 is a region where a conductive member 26 is disposed, and is heated by heat generated by the conductive member 26. The heated region 2 has vertical sides 6a and 6b that are a pair of lateral sides facing each other in the lateral direction. The glass plate 1 has a non-heated region 8. The non-heated region 8 is an upper region between the upper frame 66a of the window frame 66 (an upper side portion of the opening) and the upper portion 71 of the first bus bar 3 in the entire region viewed in the horizontal direction from the vehicle interior side.

The conductive member 26 is provided on the glass plate 1 and is positioned between the upper portions 71 and 79 and the lower portions 72 and 70. The conductive member 26 is a member through which a direct electrical current flows in an up-down direction between the upper portions 71 and 79 and the lower portions 72 and 70 when a direct voltage is applied between the first bus bar 3 and the second bus bar 4 by the power supply 400, and generates heat when the direct electrical current flows in the up-down direction. The heated region 2 is heated by the heat generated by the conductive member 26 that conductively connects the upper portions 71 and 79 and the lower portions 72 and 70. By heating the heated region 2, melting of snow, melting of ice, anti-fogging, and the like in the heated region 2 and a region in the vicinity of the heated region 2 in the glass plate 1 can be performed.

The conductive member 26 is, for example, a plurality of heating wires extending in the up-down direction of the glass plate 1 and arranged at intervals in the X-axis direction. The plurality of heating wires are, for example, wavy linear conductors extending from the first bus bar 3 toward the second bus bar 4. The heating wire is formed of, for example, copper, aluminum, chromium, molybdenum, nickel, titanium, palladium, indium, tungsten, gold, platinum, silver, or an alloy containing a plurality of these elements. The heating wire is an example of the above-described linear conductor 27.

The conductive member 26 may be a heat generating wire installed on the inner layer or the surface of the glass plate 1, or may be silver-based printing formed on the surface of the glass plate 1. The glass plate 1 may be laminated glass. Here, the phrase “the conductive member 26 is installed on the inner layer of the glass plate 1” means a configuration in which the conductive member 26 is sealed in the laminated glass.

In a case where the glass plate 1 is the laminated glass, the glass plate 1 is formed by bonding a vehicle-exterior-side glass plate provided on an outer side of the vehicle and a vehicle-interior-side glass plate provided on an inner side of the vehicle via a resin interlayer film.

The vehicle-exterior-side glass plate and the vehicle-interior-side glass plate may be inorganic glass or organic glass. As the inorganic glass, for example, soda-lime glass, aluminosilicate glass, borosilicate glass, alkali-free glass, and quartz glass are used without particular limitation. Among them, the soda-lime glass is particularly preferable from the viewpoint of production cost and moldability. A method for forming the vehicle-exterior-side glass plate and the vehicle-interior-side glass plate is not particularly limited. For example, in the case of the inorganic glass, a glass plate formed by a float method or the like is preferable.

In a case where the vehicle-exterior-side glass plate and the vehicle-interior-side glass plate are made of the inorganic glass, the vehicle-exterior-side glass plate and the vehicle-interior-side glass plate may be either untempered glass or tempered glass. The untempered glass is obtained by forming molten glass into a plate shape and slowly cooling the plate. The tempered glass is obtained by forming a compressive stress layer on a surface of untempered glass, and may be either air-cooled tempered glass or chemically tempered glass. In a case where the tempered glass is physically tempered glass (for example, the air-cooled tempered glass), a glass surface may be strengthened in a manner of generating the compressive stress layer on the glass surface by a temperature difference between the glass surface and the inside of the glass by an operation other than slow cooling, such as rapid cooling of the glass plate uniformly heated in bending from a temperature near a softening point. In a case where the tempered glass is the chemically tempered glass, the glass surface may be strengthened in a manner of generating a compressive stress on the glass surface by an ion exchange method or the like after bending. As the vehicle-exterior-side glass plate and the vehicle-interior-side glass plate, glass that absorbs ultraviolet rays or infrared rays may be used. The vehicle-exterior-side glass plate and the vehicle-interior-side glass plate are preferably transparent, but may also be colored glass plates as long as transparency is not impaired.

The glass plate 1 may have a curved shape that protrudes toward the outside of the vehicle when attached to the vehicle. The glass plate 1 may have a single curved shape bent only in one direction, or may have a double curved shape bent in two directions (for example, the up-down direction and a left-right direction orthogonal to the up-down direction when the glass plate 1 is attached to the vehicle). Gravity molding, press molding, roller molding, or the like is used for bending the glass plate 1. In a case where the glass plate 1 is bent to have a predetermined curvature, a radius of curvature of a laminated glass 110 may be 1000 mm or more and 100,000 mm or less.

When the glass plate 1 is attached to the vehicle 10, a thickness of the vehicle-exterior-side glass plate and a thickness of the vehicle-interior-side glass plate may be the same as or different from each other. The thickness of the vehicle-exterior-side glass plate is preferably 1.0 mm or more and 3.0 mm or less. In a case where the thickness of the vehicle-exterior-side glass plate is 1.0 mm or more, a strength such as a tolerance to stone chips is sufficient, and in a case where the thickness is 3.0 mm or less, a mass of the glass plate 1 does not become too large, which is preferable from the viewpoint of fuel consumption of the vehicle. The thickness of the vehicle-interior-side glass plate is preferably 0.3 mm or more and 2.3 mm or less. In a case where the thickness of the vehicle-interior-side glass plate is 0.3 mm or more, a handling property is favorable, and in a case where the thickness of the vehicle-interior-side glass plate is 2.3 mm or less, the mass does not become too large. If the thickness of each of the vehicle-exterior-side glass plate and the vehicle-interior-side glass plate is 1.8 mm or less, both weight reduction and sound insulation properties of the glass plate 1 can be achieved, which is preferable. In a case where the thickness of the vehicle-interior-side glass plate is 1.0 mm or less, the vehicle-interior-side glass plate may be the chemically tempered glass. In a case where the vehicle-interior-side glass plate is the chemically tempered glass, a compressive stress value of the glass surface is preferably 300 MPa or more, and a depth of the compressive stress layer is preferably 2 μm or more.

In a case where the glass plate 1 is the organic glass, examples of a material of the organic glass include a transparent resin such as polycarbonate or an acrylic resin (such as polymethyl methacrylate).

The conductive member 26 may be installed on the inner layer or an outer surface of the glass plate 1. The conductive member 26 is disposed on the same layer (the inner layer or the outer surface) as the first bus bar 3 and the second bus bar 4. However, the conductive member 26 may be disposed on a layer different from at least one of the first bus bar 3 and the second bus bar 4 as long as electrical connection with the first bus bar 3 and the second bus bar 4 is secured via an auxiliary member.

The heated region 2 in which the conductive member 26 is disposed may be separated into a plurality of heated regions arranged in the lateral direction. In this example, the heated region 2 has two regions arranged in the lateral direction via a gap 9 whose longitudinal direction is the up-down direction of the glass plate 1, that is, a first heated region 2a and a second heated region 2b. The heated region 2 may have three or more regions. The first heated region 2a has an upper side 6f conductively connected to the upper portion 71, a lower side 6g conductively connected to the lower portion 72, and a pair of vertical sides 6a and 6c facing each other in the lateral direction. The second heated region 2b has an upper side 6h conductively connected to the upper portion 79, a lower side 6i conductively connected to the lower portion 70, and a pair of vertical sides 6b and 6d facing each other in the lateral direction.

In the example illustrated in FIG. 6, since the heated region 2 is divided into the plurality of heated regions, each of the first bus bar 3 and the second bus bar 4 is also divided. The first bus bar 3 includes a first upper bus bar 3a and a second upper bus bar 3b, and the second bus bar 4 includes a first lower bus bar 4a and a second lower bus bar 4b.

The first bus bar 3 may further include a vertical portion connected to the upper portions 71 and 79. In the first bus bar 3 illustrated in FIG. 1, the first upper bus bar 3a includes a vertical portion 73 connected to the upper portion 71, and the second upper bus bar 3b includes a vertical portion 76 connected to the upper portion 79. The upper portion 71 is a conductor portion connected to the upper side 6f of the first heated region 2a, and the vertical portion 73 is a conductor portion extending in a direction along the left edge 1c which is one side edge of the glass plate 1 away from the vertical side 6a which is one side edge of the first heated region 2a. The upper portion 79 is a conductor portion connected to the upper side of the second heated region 2b, and the vertical portion 76 is a conductor portion extending in a direction along the right edge 1d, which is the other side edge of the glass plate 1 away from the vertical side 6b, which is one side edge of the second heated region 2b.

Since the first bus bar 3 includes the vertical portions 73 and 76 respectively connected to the upper portions 71 and 79, a part of a wiring line electrically connecting the upper portions 71 and 79 of the first bus bar 3 to the power supply 400 can be provided on the glass plate 1 instead of the vehicle body. Thus, (a length of) a harness wired on the vehicle body can be reduced.

As illustrated in FIG. 6, the first bus bar 3 may further include a lateral portion 74 connected to the vertical portion 73, and may further include a lateral portion 77 connected to the vertical portion 76. The lateral portion 74 is a conductor portion extending in a direction along the lower edge 1b of the glass plate 1 in a region away from the first heated region 2a. The lateral portion 77 is a conductor portion extending in a direction along the lower edge 1b of the glass plate 1 in a region away from the second heated region 2b. Due to the presence of the lateral portion 74 or the lateral portion 77, (the length of) the harness can be further reduced depending on a position of a terminal of the harness to be wired on the vehicle body.

In the example illustrated in FIG. 6, the glass plate 1 includes a plurality of electrodes 51, 52, 55, and 56 to which terminals of a plurality of harnesses electrically connected to the power supply 400 are electrically connected.

The electrode 51 is a negative electrode for electrically connecting a terminal of a ground harness 53 electrically connected to the negative electrode terminal 402 to the first upper bus bar 3a. The electrode 51 is electrically connected to the upper portion 71 via the lateral portion 74 and the vertical portion 73.

The electrode 52 is a negative electrode for electrically connecting a terminal of a ground harness 54 electrically connected to the negative electrode terminal 402 to the second upper bus bar 3b. The electrode 52 is electrically connected to the upper portion 79 via the lateral portion 77 and the vertical portion 76.

The electrode 55 is a positive electrode for electrically connecting a terminal of a power supply harness 57 electrically connected to the positive electrode terminal 401 to the first lower bus bar 4a. The first lower bus bar 4a includes a connection bus bar 75 connected to the lower portion 72. The electrode 55 is electrically connected to the lower portion 72 via the connection bus bar 75.

The electrode 56 is a positive electrode for electrically connecting a terminal of a power supply harness 58 electrically connected to the positive electrode terminal 401 to the second lower bus bar 4b. The second lower bus bar 4b includes a connection bus bar 78 connected to the lower portion 70. The electrode 56 is electrically connected to the lower portion 70 via the connection bus bar 78.

The antenna 30 performs transmission and reception (at least one of transmission and reception) of a radio wave in a predetermined frequency band F. The radio wave in the predetermined frequency band F may be a vertically polarized wave, a horizontally polarized wave, or a circularly polarized wave. The antenna 30 is formed to be able to transmit and receive a radio wave in a high frequency band (for example, 0.3 GHZ to 300 GHz) such as a microwave and a millimeter wave, for example. The antenna 30 is suitable as a vehicle antenna if a radio wave including at least one of a 5.8 GHz band and a 5.9 GHZ band can be transmitted and received. The antenna 30 is applicable to, for example, a V2X communication system, a fifth generation mobile communication system, a sixth generation mobile communication system, and an in-vehicle radar system, but applicable systems are not limited thereto. Specific examples of the V2X communication system used in an intelligent transport system (ITS) and the like include a vehicle-to-vehicle communication system and a road-to-vehicle communication system (for example, an electronic toll collection (ETC) system).

The antenna 30 is disposed in a space near the glass plate 1. Therefore, the antenna gain of the antenna 30 in the frequency band Fis less likely to be affected by a size of the heated region 2. Therefore, the antenna 30 capable of securing the antenna gain in the predetermined frequency band F can coexist with the heated region 2. The antenna 30 is fixed to the main surface 22 of the glass plate 1 or a ceiling of a vehicle compartment via an indirect member (not illustrated) such as a bracket or a housing so as to be disposed in a space near the upper portion 71 of the first bus bar 3.

In addition, the antenna 30 includes a conductor 37 facing the glass plate 1 away from the glass plate 1. The conductor 37 may be a ground plane of the antenna 30 or a radiating element of the antenna 30. Since the conductor 37 is separated from the glass plate 1 and faces the glass plate 1, the antenna gain of the antenna 30 in the frequency band F is hardly affected by the size of the heated region 2. Therefore, the antenna 30 capable of securing the antenna gain in the predetermined frequency band F can coexist with the heated region 2. In the example illustrated in FIG. 6, the antenna 30 is close to the upper portion 71 of the first bus bar 3 from the viewpoint of the vehicle interior side. In particular, the antenna 30 is disposed below the upper portion 71 with a predetermined gap from the viewpoint of the vehicle interior side.

In the window glass device 301 for a vehicle, a projection surface 13 on which the conductor 37 is projected onto the glass plate 1 from the horizontal direction overlaps the heated region 2. Further, when the projection surface 13 of the conductor 37 overlaps the upper portion 71 of the first bus bar 3, there is a possibility of interfering with a radio wave coming from above the vehicle or radiated to above the vehicle. Therefore, the projection surface 13 is preferably disposed so as not to overlap the first bus bar 3.

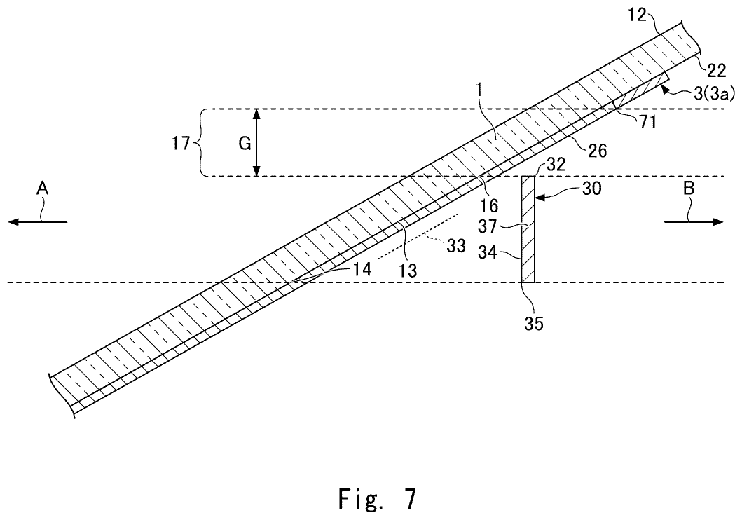

FIG. 7 is a cross-sectional view illustrating an upper portion of a specific example of the window glass for a vehicle. The glass plate 1 has the main surface 12 facing a vehicle exterior side A and the main surface 22 facing the vehicle interior side. In FIG. 7, the conductive member 26 is provided on the main surface 22, but may also be provided on the inner layer of the glass plate 1.

As illustrated in FIG. 7, it is preferable that a gap 17 exists between the conductor 37 and the upper portion 71 of the first bus bar 3 in a plan view from the vehicle interior side. Due to the presence of the gap 17, a radio wave radiated from the antenna 30 is hardly blocked by the upper portion 71, so that the antenna gain in the predetermined frequency band F can be secured. The projection surface 13 has a lower end 14 on which a lower end 35 of the conductor 37 is projected and an upper end 16 on which an upper end 32 of the conductor 37 is projected.

In FIG. 6, the antenna 30 transmits and receives a vertically polarized wave, for example. In a form in which the conductive member 26 provided in the heated region 2 is formed of the plurality of linear conductors extending in the up-down direction of the glass plate 1 and arranged in the lateral direction, the vertically polarized wave parallel to a longitudinal direction of the plurality of linear conductors is easily blocked by the conductive member 26. However, the window glass 100 satisfies the above requirement R, thereby securing the antenna gain in the predetermined frequency band F. Therefore, even in a case where the antenna 30 is spatially disposed such that the projection surface 13 overlaps the heated region 2, it is possible to suppress a decrease in the antenna gain in the predetermined frequency band F.

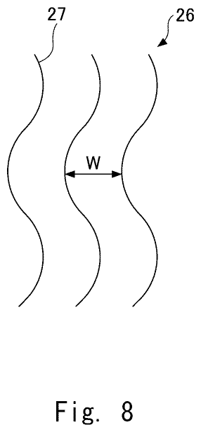

FIG. 8 is a front view illustrating the plurality of linear conductors 27 included in the conductive member 26 on the projection surface 13 on which the conductor 37 of the antenna 30 is projected onto the glass plate 1 from the horizontal direction. In this case, the pitch W between the plurality of adjacent linear conductors 27 is a dimension of the sinusoidal linear conductor 27 in an amplitude direction. As described above, in a case where the pitch W is 2 mm or more and 4 mm or less, the transmittance of the radio wave P in the 5.8 GHz band or the 5.9 GHz band is secured while securing the original performance of the linear conductors 27.

In FIGS. 6 and 7, in a plan view of the glass plate 1, when a gap length G in a vertical direction between the projection surface 13 and the upper portion 71 is 0.25λ (=λ/4) or more, the radio wave radiated from the antenna 30 is hardly blocked by the upper portion 71, so that the antenna gain in the predetermined frequency band F can be secured.

From the viewpoint of securing the antenna gain, the gap length G is preferably 0.35λ or more, and more preferably 0.50λ or more. A wavelength of the radio wave transmitted and received by the antenna 30 in the air is λ.

The antenna 30 has a radiation surface 34 (see FIG. 7) that emits the radio wave. The window glass device 301 for a vehicle may include a dielectric 33 having a relative permittivity greater than 1 between the glass plate 1 and the radiation surface 34. A frequency characteristic of the antenna 30 can be adjusted by the dielectric 33. The dielectric 33 may be a spacer or a matching film. The dielectric 33 may be a member containing a resin.

The radiation surface 34 may be disposed substantially parallel to the vertical direction as illustrated in FIG. 7, or may be disposed substantially parallel to the glass plate 1 although not particularly illustrated.

### Example 1

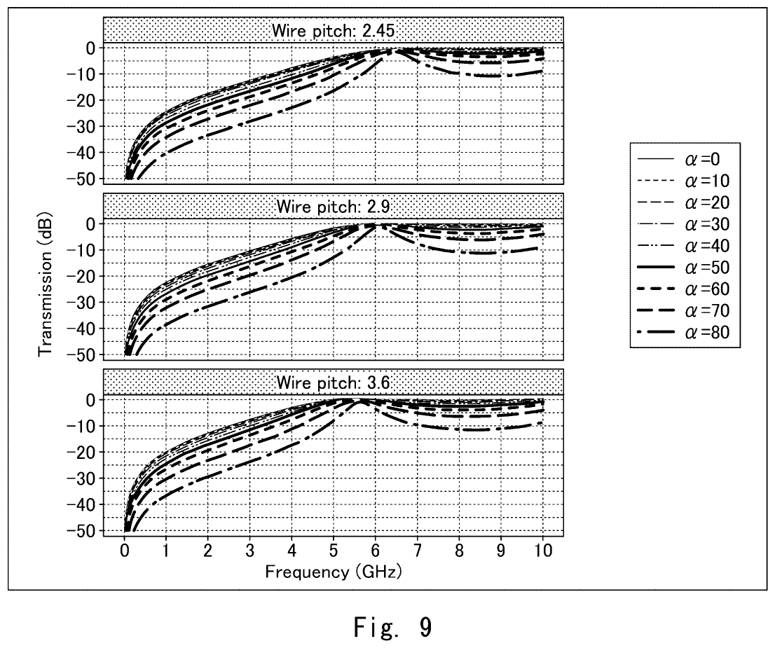

FIG. 9 is a diagram illustrating an example of a relationship among the pitch W between adjacent linear conductors 27, the incident angle α of the radio wave P on the glass plate 1, the frequency of the radio wave P, and the transmittance of the radio wave through the glass plate 1. A transmission characteristic at the incident angle α from −80° to 0° is similar to a transmission characteristic at the incident angle α from 0° to 80°, and thus is omitted. The transmittance on a vertical axis is S21 which is one of the S parameters. S21 represents a transmission coefficient (transmittance) of the radio wave. A larger value of S21 indicates a higher radio wave transmittance in the region 24. As the pitch W is changed, the frequency of the radio wave P having a high transmittance changes.

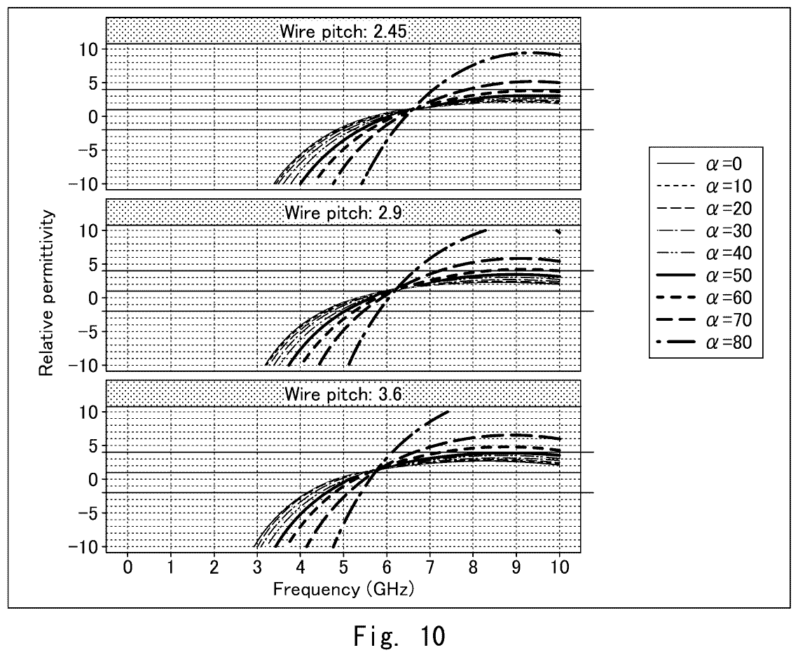

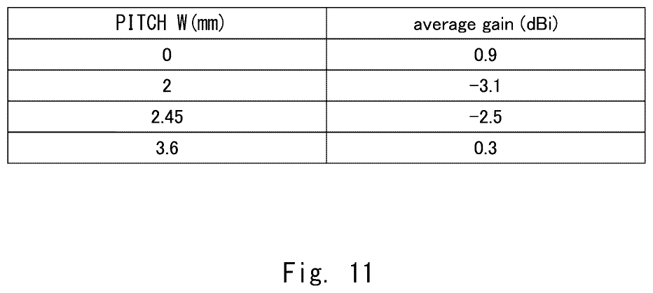

FIG. 10 is a diagram illustrating an example of a relationship among the pitch W between adjacent linear conductors 27, the incident angle α of the radio wave P on the glass plate 1, the frequency of the radio wave P, and the effective relative permittivity εₑ. The effective relative permittivity εₑ on a vertical axis in FIG. 10 is a value calculated by an electromagnetic field simulator based on the calculation method disclosed in Non Patent Literature 1 using the S parameters (S11 and S21) measured in FIG. 9.

In FIG. 10, if the requirement R that the relative permittivity εₑ is −2 or more and 4 or less is satisfied in the range of a from −45° to +45°, the transmittance of the radio wave P incident on the glass plate 1 at the incident angle α from −80° to +80° is secured. In addition, by setting the pitch W to 3.6 mm, the relative permittivity εₑ at a frequency included in at least one of the 5.8 GHz band and the 5.9 GHz band is −2 or more and 4 or less even when α is +80°. Therefore, in FIGS. 9 and 10, as the pitch W is set to 3.6 mm, even in a case where the radio wave P having a frequency included in at least one of the 5.8 GHz band and the 5.9 GHz band is incident on the glass plate 1 at the incident angle α from −80° to +80°, the radio wave P is transmitted through the glass plate 1 with little attenuation.

### Example 2

FIG. 11 is a diagram illustrating an example of a result of actually measuring an average antenna gain of a horizontal plane of an antenna installed in a vehicle compartment using an actual vehicle to which the window glass 100 of the present embodiment is attached as a windshield. The average antenna gain represents an average value of antenna gains measured in each angular direction included in a vehicle front range of ±60° in the horizontal plane by changing the frequency of the radio wave P in the 5.8 GHz band and the 5.9 GHZ band. That is, this example corresponds to a case where the radio wave P is incident on the glass plate 1 at the incident angle α from −60° to +60°. In addition, the windshield of the actual vehicle was measured in a state of being inclined at about 25° with respect to the horizontal plane.

A case where the pitch W is 0 represents a comparative example in which the linear conductor 27 does not exist. In a case where the pitch W is 3.6 mm, the degree of decrease in the average antenna gain in the 5.8 GHz band and the 5.9 GHz band is lower than that in a case where the pitch W is 2 mm or 2.45 mm. As described above, it can be seen that the transmittance of the radio wave P in the 5.8 GHz band and the 5.9 GHz band is improved even when the window glass 100 is inclined with respect to the horizontal plane by setting the pitch W to 3.6 mm in a range of 2 mm or more and 4 mm or less.

As described above, the embodiment has been described, but the above embodiment is presented as an example, and the present invention is not limited by the above embodiment. The above-described embodiment can be implemented in various other forms, and various combinations, omissions, substitutions, changes, and the like can be made without departing from the gist of the invention. These embodiments and modifications thereof are included in the scope and gist of the invention, and are included in the invention described in the claims and the equivalent scope thereof.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A window glass for a vehicle, comprising:
a glass plate having a main surface; and
a plurality of linear conductors provided on the glass plate, extending in a first direction along the main surface, and arranged at intervals in a second direction which is at a right angle to the first direction,
wherein εₑ is −2 or more and 4 or less when α is in a range from −45° to +45°, in which a direction which is at a right angle to the first direction and the second direction is a third direction, a plane including the second direction and the third direction is a first plane, a direction in which a radio wave having a component whose electric field oscillates in a direction perpendicular to the first plane travels along the first plane is a first traveling direction, an angle formed by the first traveling direction and the third direction is α, and an effective relative permittivity at a frequency of the radio wave in a region where the plurality of linear conductors are provided on the glass plate is εₑ.

2. The window glass for a vehicle according to claim 1, wherein the interval in the second direction is 2 mm or more and 4 mm or less.

3. The window glass for a vehicle according to claim 1, wherein εₑ at a frequency included in at least one of a 5.8 GHz band and a 5.9 GHz band is −2 or more and 4 or less when α is +80°.

4. The window glass for a vehicle according to claim 1, wherein the plurality of linear conductors are heating wires.

5. The window glass for a vehicle according to claim 1, wherein the plurality of linear conductors are provided on an inner layer of the glass plate.

6. The window glass for a vehicle according to claim 1, wherein the window glass for a vehicle is used for a windshield.

7. The window glass for a vehicle according to claim 1, wherein the window glass for a vehicle is used for a rear glass.
